(19) United States
(12) Patent Application Publication
(10) Pub. No.: US 2014/0195461 A1
(43) Pub. Date: Jul. 10, 2014

(54) DAILY EQUITY BASED TAX SOLUTION

(71) Applicant: United Technologies Corporation, Hartford, CT (US)

(72) Inventors: Marc J. Fafard, Southington, CT (US); Denise Ralls-Gaines, Meriden, CT (US)

(21) Appl. No.: 13/837,096

(22) Filed: Mar. 15, 2013

Related U.S. Application Data
(60) Provisional application No. 61/750,534, filed on Jan. 9, 2013.

(51) Int. Cl. G06Q 40/00

(52) U.S. Cl. CPC G06Q 40/00
USPC 705/36 T

(57) ABSTRACT

In a computer-implemented method for managing tax withholding liabilities, a notification of a non-standard compensation transaction is received. The non-standard compensation transaction is initiated during a time period covered by the notification. A resulting tax withholding liability is automatically calculated. A directive is automatically generated for directing a calculated tax withholding payment to be made and applied against the calculated tax withholding liability. The calculated payment is to be made to a tax authority on or before a calculated due date of the tax withholding liability.

### BACKGROUND

The described subject matter relates generally to methods for managing tax withholding liabilities, and more specifically to methods for managing tax withholding liabilities arising from non-standard employee compensation.

In most cases, employers are ultimately charged with the responsibility for federal and state employment tax deduction and withholding on behalf of their employees (See, e.g., Internal Revenue Code §§3102(a), 3402(a)). The employer is subject to withholding liabilities when wages are actually or constructively paid to the employee or other beneficiary. Under federal law, responsibility for withholding liabilities generally extends to all pay provided to an employee in exchange for services performed, regardless of the form of remuneration. Thus wages subject to employment tax will generally include compensation resulting from many employer equity plans unless that type of compensation is specifically excluded from employment taxes and/or withholding requirements by law or regulation. Example exclusions under current federal law include Incentive Stock Options (ISOs) and Employee Stock Purchase Plan Options, which are tied to stock that is regularly held for investment.

Employers are generally required to deposit the taxes withheld from the employees' pay (as well as the employer's own share of employment taxes) based on either a regular semi-weekly or monthly schedule. However, current regulations also can require the employer to deposit employment taxes more frequently than their regular schedule dictates. (See, e.g., 2012 Internal Revenue Service Publication 80, “$100,000 Next Day Deposit Rule”). Since non-standard compensation transactions can be initiated and/or settled on any given banking day, it is not advisable for companies utilizing certain equity plans to rigidly follow the semiweekly or monthly rules. Failure to pay tax withholding liabilities within the regulatory framework can result in a penalty ranging from 2%-15% of the identified underpayment. These penalties represent significant but avoidable costs for employers.

As a result, employers (or vendors acting on their behalf) have developed various methods and systems intended to increase regulatory compliance and reduce penalties related to underpayment of withholding liabilities. In one example, employers have made periodic prepayments (e.g., monthly or quarterly) to cover possible withholding liabilities. However, in the case of equity-based and other non-standard compensation transactions, prepayments are made before most actual transactions are initiated, leaving the employer to guess as to the full extent of withholding liabilities when making the monthly or quarterly payment. Thus without continuous monitoring and intervention, periodic prepayments retain a high risk of substantial underpayment, as well as overpayment. Large periodic prepayments may mitigate most liability but can also hinder cash flow. Overpayment also carries other risks such as garnishment detailed below. As such, periodic prepayments provide minimal savings in resources, and carry little assurance that they will be sufficient to avoid substantial underpayment penalties and other risks.

There is currently no system for automatically managing daily tax withholding liabilities and integrating tax payments with standard payroll systems, including enabling coordinated accurate information reporting (e.g., Form W-2s and Forms 941), while ensuring that all tax withholding liabilities are accurately paid and applied on a timely basis.

### SUMMARY

In a computer-implemented method for managing tax withholding liabilities, a notification of a non-standard compensation transaction is received. The non-standard compensation transaction is initiated during a time period covered by the notification. A resulting tax withholding liability is automatically calculated. A directive is automatically generated for directing a calculated tax withholding payment to be made and applied against the calculated tax withholding liability. The calculated payment is to be made to a tax authority on or before a calculated due date of the tax withholding liability.

In a computer-implemented method for managing tax payments for non-standard compensation transactions, a first electronic data file is received. The first electronic data file contains details of any non-standard compensation transactions initiated during a notification time period. One or more resulting tax withholding liabilities are automatically calculated. A second electronic data file is automatically generated, which contains a tax payment directive for a tax payment module. The tax payment module is directed to make and apply a tax withholding payment against the one or more calculated tax withholding liabilities on or before a due date.

In a computer-implemented method for managing tax withholding liabilities using a payroll system, a directive for making a first tax payment is received after initiation of a non-standard compensation transaction. A calculated tax withholding payment is made as described in the directive. The payment is made on or before a due date of a calculated tax withholding liability resulting from the non-standard compensation transaction. The payroll system is prevented from making a subsequent tax withholding payment substantially duplicative of the calculated tax withholding payment.

### BRIEF DESCRIPTION OF THE DRAWINGS

FIG. 1 is a flow chart showing a method for managing tax withholding liabilities resulting from a non-standard compensation transaction.

FIG. 2A shows a first example computer system for managing tax withholding liabilities for non-standard compensation.

FIG. 2B shows a second example computer system for managing tax withholding liabilities for non-standard compensation.

FIG. 2C shows a third example computer system for managing tax withholding liabilities for non-standard compensation.

FIG. 3 is a flow chart showing a method for managing tax withholding liabilities using a payroll system.

### DETAILED DESCRIPTION

Ordinary periodic (e.g., bi-weekly, semi-monthly, or monthly) business payroll events and the related payroll tasks are usually scheduled using a rigorous calendaring process. An ordinary payroll period typically closes 2-5 business days ahead of the actual payroll event, with the accompanying tax withholding payments typically coming due soon thereafter.

A business unit (either independent or affiliated with other business units) may employ a substantial number of high-level employees or other personnel (e.g., executives, board members, special advisors, etc.). These personnel often negotiate comprehensive compensation packages, which may include both standard compensation and non-standard compensation in exchange for their services to the business unit. Standard compensation can include, but is not limited to, salary, performance bonuses, advances against expected profit sharing, clothing and travel allowances, as well as many other payments generally made in cash or cash equivalents. Standard compensation can be paid as part of an ordinary periodic payroll event. Non-standard compensation typically includes one or more types of equity-based compensation in which compensation of high-level personnel may include cash, securities or other instruments. The value of non-standard compensation is ostensibly tied to one or more company performance metrics, rather than being a fixed cash value.

A non-standard compensation transaction, such as exercising of certain stock options and/or stock appreciation rights, can be initiated or exercised by the employee. Options or other transactions may also have time-based restrictions such as a vesting date or a minimum holding period, after which they may be initiated automatically, or at the request of the beneficiary. Other types of non-standard compensation such as performance stock units, restricted stock, or restricted stock units may operate solely with a time-based restriction such as vesting date, upon which the employee receives an unfettered right to the underlying value. Tax withholding liabilities, particularly for these and other transactions, are often due and payable to a tax authority more frequently than withholding liabilities arising from ordinary payroll events.

Under current regulations, tax withholding payments may be due to the tax authority as frequently as each business or funding day. (See, e.g., 2012 IRS Publications 15 and 80). Current regulations also typically permit only a single tax return (e.g., IRS Form 941) and a single payment per business unit for each funding day, further complicating the process of ensuring timely payment and accurate accounting of tax withholding liabilities. Even though different parts of the compensation process may be managed by multiple parties (e.g., brokerage firm, payroll vendor, accounting vendor, and/or business consultants); the employer is ultimately held responsible for compliance. And while certain examples are described generally with respect to current federal tax law, as well as IRS regulations and practices, such examples are for the sake of clarity and are not intended to limit the applicability of the described subject matter. For example, tax authorities representing various state and local government subdivisions may also, either currently or in the future, enforce rules calling for funding of certain tax withholding liabilities more frequently than their standard funding schedules. Further, many state and local government subdivisions conform or derive key regulations from federal tax law and practices. Thus it will be recognized that the subject matter can be adapted to tax authorities other than the IRS, and can in certain embodiments, can be incorporated into computer systems and modules covering more than one tax authority.

Non-standard compensation can be provided through individual employee accounts held by a brokerage firm or other outside vendor or consultant. While some brokerage firms may withhold some or all of an employee's share of employment taxes, the brokerage is not responsible for calculating or paying the full amount of employment taxes (including both employer and employee shares) owed by the employer.

Standard compensation can be paid through ordinary payroll events which are frequently managed at least in part by a specialized payroll vendor or consultant. While these vendors may specialize in handling standard compensation and the resulting tax withholding requirements, they do not currently provide adequate services related to integrating frequent non-standard compensation transactions into their payroll and tax management systems. Thus any reporting of non-standard compensation transactions and tax withholding by the brokerage firm has typically been handled through ordinary payroll cycles.

Payroll vendors typically utilize a system with a tax payment module configured to interface directly with the vendor's payroll module. The tax module transmits any tax withholding payments recorded therein. This configuration reduces errors in recording compensation and tax withholding payments so that the vendor's business unit clients can meet any consolidated employer and employee reporting requirements. However, existing payroll systems and vendors are not presently equipped to accurately integrate more frequent reporting of non-standard compensation, or payment of the resulting tax withholding liabilities.

The delay between the non-standard compensation withholding liability and related tax deposit due date, and the actual date on which the liabilities are remitted through ordinary payroll cycles typically subjects employers to late deposit penalties up to 15% of unpaid liabilities. Payroll systems typically record the liability date for non-standard compensation as the pay date of the ordinary payroll cycle in which it is included, not the actual liability date of the transaction. As such, these penalties are not “automatically” assessed when employers file the related tax returns, but typically are assessed under IRS audit.

Previous methods to manage tax withholding liabilities and reduce late payment penalties include making substantial prepayments to the tax authority. These prepayments would be made quarterly, well in advance of knowing the full extent of any non-standard compensation payable over the quarter, and well in advance of any due dates of the resulting withholding liability. For example, a business unit may determine a range of total non-standard compensation payable over the following quarter based on historical measures and a range of expected stock prices. The business unit may then prepay an amount to the tax authority at the beginning of the quarter covering the range of possible liabilities prior to any non-standard compensation transaction actually being initiated or settled. However, to maintain even cursory regulatory compliance, this method requires frequent monitoring of actual transactions, account balances, and manual calculation of tax withholding liabilities on a daily or weekly basis.

Even if the large prepayment turns out to be sufficient, this can unnecessarily tie up several million dollars of operational cash flow, particularly if such liabilities never materialize. This prepayment approach also typically requires unused withholding payments to be manually reversed out of the tax system in the last payroll of each quarter, with a new prepayment being redeposited as soon as possible after the start of the following quarter. This is done to prevent the unused prepayment from being reported as an actual liability on quarterly or annual tax returns. This also limits the ability of the government authority to garnish any unused prepayment at the end of the quarter for use against any other tax liabilities or unrelated government assessments. But even if the prepayment process is executed flawlessly, the business unit will not have prepayment protection for one or more days between closing the last payroll period of a quarter and the last day of the quarter.

Thus, methods and systems are described for managing tax withholding liabilities resulting from non-standard compensation transactions. Generally, an equity-based tax management system or module receives a notification of non-standard compensation transactions. The system or module calculates the tax withholding amounts that are due, based at least in part on the information received from the brokerage module, and then directs a separate tax management module to make tax withholding payments against the calculated withholding liabilities. Accounting entries can be generated to record any tax payments in the business unit's accounting system(s). These or other accounting entries can result in the accounting system(s) taking the required steps to ensure sufficient funding of tax payments. The system or module can also prevent excess or duplicate withholding payments that could result from subsequently reporting non-standard compensation and/or withholding payments through the payroll system.

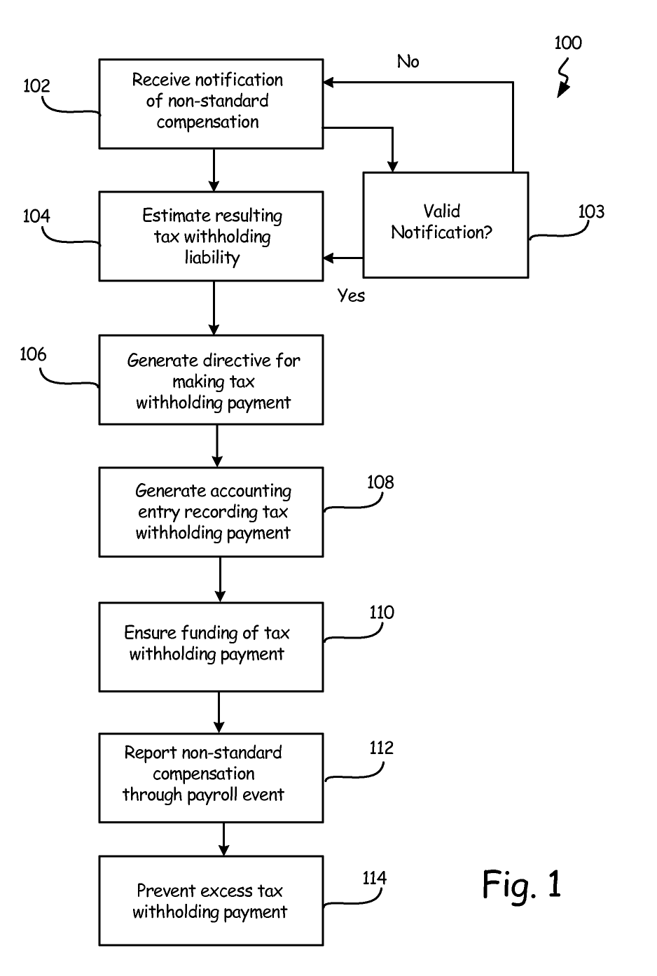

FIG. 1 shows method 100 for managing tax withholding liabilities for a non-standard compensation transaction. Generally, step 102 includes receiving a notification of whether or not a non-standard compensation transaction has been initiated during a time period covered by the notification. Step 103 describes optionally validating the received notification. In step 104, a tax withholding liability is automatically calculated, which is payable to a tax authority. Step 106 includes automatically generating a directive for a payment to be made to the tax authority on or before a due date of the tax withholding liability. Step 108 includes automatically generating an accounting entry for recording the payment to the tax authority. Step 110 ensures that the payment to the tax authority described in the directive is sufficiently funded. At step 112, the non-standard compensation transaction and the tax withholding payments are optionally reported. Step 114 includes preventing an excess withholding payment to the tax authority. Examples and variations on each step of method 100 are described in turn.

At step 102, a business unit (BU) receives a notification of whether or not a non-standard compensation transaction has been initiated during a time period covered by the notification. Generally, the business unit, or a computerized accounting module operated on behalf of the business unit, receives the notification which can include aggregated and/or detailed data reflecting any non-standard compensation transactions taking place during the time period.

The notification can be provided from a brokerage firm or other third party. In certain embodiments, the notification also includes details on the employee's share of one or more employment taxes. In certain embodiments, the notification itself can be received directly by a business unit funding the tax withholding liability. Alternatively, the notification is received by a vendor providing payroll and/or business consulting services to the business unit.

In one example, a business unit provides non-standard compensation in the form of cash, securities or other instruments. The instruments may be maintained in an account under the control of the business unit until such time as a non-standard compensation transaction is initiated or exercised. Settlement of the transaction results in the instrument or cash equivalent being deposited or transferred into a brokerage account on behalf of the beneficiary (e.g., an employee, board member, or adviser). Some transactions are initiated or exercised at the request of the beneficiary. Others are initiated after expiration of a vesting period. There is typically a time lag of one or more business days between initiation or exercise of the non-standard compensation transaction, and settlement of the transaction.

After initiation or exercise of a non-standard compensation transaction, a due date of any resulting tax withholding liability can then be more precisely calculated. Current IRS regulations (See, e.g., 2012 IRS Publication 80) indicate that tax withholding liabilities are due on a funding day immediately following any business day during which cumulative unpaid tax withholding liabilities for a particular federal employer identification numbers (FEIN) reach $100,000 (IRS $100,000 Next Day Funding Rule). If the liabilities are not paid on time, the business unit is subject to substantial penalties and increased audit risk. A business unit may be identifiable by one or more FEIN's.

Since tax withholding liabilities are potentially due each and every funding day, some withholding liabilities are due during an ordinary payroll period. Thus the calculated due date can precede a due date for tax withholding liabilities resulting from an ordinary payroll event. As such, the notification time period can be less than an ordinary payroll time period.

In certain embodiments tailored to current regulations, the time period can be as short as a single business day or market day immediately preceding scheduled receipt of the notification. However, it will be recognized that step 102 can be adapted to a notification time period and a threshold liability amount according to any regulatory changes. In certain computer-implemented embodiments of method 100, a computer module can be programmed to reflect a notification time period that allows sufficient time for performing subsequent steps.

As part of step 102, it will be recognized that there may be time periods during which no non-standard compensation transaction has occurred during the notification time period. In certain of these embodiments, the notification step includes automatically generating an alert to that effect. The alert can be as simple as an electronic message or a notification file containing no transaction data.

To ensure proper payments are made, integrity of the notification can optionally be validated according to step 103, prior to proceeding to step 104 below. As part of validating the data, the notification can be cross-checked against tax withholding regulations applicable to a particular beneficiary and/or transaction. For example, inactive employees, hourly employees, or other groups may be exempt from some or all withholding requirements. Other employees can be filtered out at this stage. For example, the filtered employee (or group of employees) may be subject to separate payroll and/or tax management processes outside the scope of this disclosure.

In certain embodiments, validation step 103 includes automatically generating an alert if the receiving step has not occurred within an expected time interval after the end of the time period covered by the notification. The end of the applicable time period can be the close of a trading day on a particular exchange. In one example, a notification for that trading day is expected to be received (or otherwise made available for retrieval) within four hours after the close of trading. If the notification has not been received or made available for retrieval at the end of that four hour interval, an alert can be automatically generated by an appropriately programmed computer system or module, such as an equity based tax management module.

Step 104 includes automatically calculating a tax withholding liability payable to a tax authority. In certain embodiments, this step is performed in response to receiving the notification of step 102. Calculation of a tax withholding liability resulting from a non-standard compensation transaction can be automatically performed by a BU accounting system and/or a dedicated computer module. Examples of tax withholding liabilities include federal income taxes, FICA taxes, and any other liabilities indicated in regulations then in effect. The tax withholding liability can be calculated at least in part based on information received as part of the notification. For example, the notification can contain details of the non-standard compensation transaction(s) as well as the employee's share of one or more employment taxes. The calculated tax withholding liabilities can include some or all of the employee's share of employment taxes (e.g., federal income tax withholding, employee Social Security tax, and/or employee Medicare tax), as well as employment taxes owed directly by the employer (e.g., employer Social Security tax, and/or employer Medicare tax).

Step 104 can also include determining one or more due dates of the calculated tax withholding liabilities. As described above, tax withholding liabilities may be due and payable more than once during an ordinary payroll cycle. One example of this is the IRS next day funding rule. Thus the due date can be determined based on a date that the transaction proceeds are available, which is typically the settlement date. The settlement date in turn can be dependent on the exercise date (or the effective date on which the transaction is initiated), and the type of non-standard compensation. As noted above, a common type of non-standard compensation transaction is an equity-based transaction based directly or indirectly on a market value of the business. Common examples of equity-based compensation subject to tax withholding regulations include stock appreciation rights (SAR), non-qualified stock options (NQSO), restricted stock (RS), restricted stock units (RSU's), and performance stock units (PSU's). Other forms of equity-based compensation, such as stock swaps, can also be included. Other types of compensation can be specifically excluded from wages subject to federal employment taxes. Under current law and regulations, examples of excluded compensation include Incentive Stock Options (ISOs) and Employee Stock Purchase Plan Options.

At step 106, a directive is automatically generated directing a payment to be made to the tax authority on or before a due date of the tax withholding liability. The directive can include applying the payment against the calculated tax withholding liability, and can optionally be made directly in response to receiving the periodic notification or estimation of the tax withholding liability. The directive can be automatically generated by the BU accounting system and/or a dedicated computer module in response to calculating tax withholding liabilities. The directive can be transmitted to or retrieved by a computerized tax payment system or module managed by a payroll provider. To minimize penalties and audit risk, an amount of the calculated tax withholding payment can be equal to or greater than the calculated liability.

Steps 108 and 110 can be performed in response to any of the preceding steps. At step 108, an accounting entry can be automatically generated for recording the payment made to the tax authority. Step 110 can, in turn, also ensure that the payment to the tax authority described in step 106 is sufficiently funded. Depending on configuration of a particular business unit accounting system and/or tax management module, the accounting entry for recording the payment (step 108) can also automatically trigger a funding request (step 110) within the business unit, so that funds are made available for remitting any tax payments covered by the directive(s) of step 106. Alternatively, step 110 includes separately generating a funding request to be handled by the business unit accounting system. In one example of a self-managed payroll system, steps 108 and/or 110 can result in funds for the tax withholding payment to be transferred internally to a payroll or tax account from one or more operating accounts. In the case of vendor-managed payroll systems, steps 108 and/or 110 can then allow for, or trigger, a fund transfer from a BU account to a vendor account tied to their dedicated tax payment module.

Step 112 includes reporting the non-standard compensation transaction and the tax withholding payments through a payroll system. The payroll system can receive a separate report of the non-standard compensation transaction at or just prior to the end of a payroll period in which the transaction was initiated. One or more accounting entries can be automatically generated which reflect the amount of reported nonstandard compensation, as well as any corresponding daily tax withholding payments. These entries can be generated separately by a different accounting module such as an accounts payable module and/or a general ledger module. Alternatively, they can be performed in conjunction with one or more of the preceding steps.

In certain embodiments, the compensation and tax withholding data are reported through an ordinary payroll event. In certain alternative embodiments, the compensation and tax withholding data are reported separately from an ordinary payroll event. This can be done through an out-of-sequence (OOS) payroll event by the payroll vendor, or directly by the business unit. In either case, the prior steps help ensure that any compensation and tax withholding payments are accurately recorded in the payroll system. Entries can be reported periodically to a separate payroll system or module to facilitate compliance with tax and employment regulations, which effectively require that employee compensation be reported to the tax authority and to the employee in different formats at different times. For example, a business unit (or its representative) reports periodic federal tax withholding payments to the IRS on Form 941, while those periodic payments are usually reported to the employee as part of ordinary periodic payroll events. The business unit or representative also reports aggregated compensation and withholding data to both the employee and the tax authority after the close of a tax year or its equivalent. For both accounting and compliance reasons, the amounts shown on these forms must agree.

In one example, a BU accounting system receives accounting entries generated during step 106. The BU accounting system aggregates individual accounting entries and transmits them to the payroll vendor for reporting as part of the ordinary payroll event. In certain alternative embodiments, the BU accounting system transmits entries to the payroll vendor more frequently than an ordinary payroll period. This can be an OOS payroll event scheduled to handle bonuses or several non-standard compensation transactions completed on a single day.

In certain embodiments, step 112 is performed by a different accounting system module than the remainder of method 100. One accounting system module can perform steps 102, 104, 106, 108, and/or 110, while a separate accounts payable module (or equivalent) can independently send instructions to a payroll module as part of step 112. Reporting entries are sent to the payroll module (which can be operated by a payroll vendor) by the accounts payable module (or other module).

In certain embodiments, the BU accounting system receives a report of the actual non-standard compensation transactions on or around the closing day of the ordinary payroll period. It will be appreciated that there can be some deviation between the data contained in the periodic notification (step 102) versus actual transaction settlement data contained in the close-of-payroll report. Since the periodic notification is based on the initiation or exercise date, a number of factors (e.g., market fluctuations, adjustments made after market close, incomplete transaction data) will determine the actual value of non-standard compensation received by the beneficiary after settlement. This in turn will affect the actual tax withholding liability on that non-standard compensation. However, overestimation of liabilities for any particular transaction is just as likely to occur as underestimation, so minor errors in withholding payments are likely to balance out over one or more funding days. Further, regulations allow for substantial compliance (e.g., less than 2% underpayment) with little or no penalty if the underpayment is reconciled in a timely manner. In certain embodiments, a minimal deposit cushion can be established with the tax authority and/or payroll vendor to handle minor deviations between the daily withholding calculations and the final settlement amounts. However, any deposit cushion will be much smaller than would be required under the periodic (monthly or quarterly) prepayment scenarios described above.

In certain alternative embodiments of step 112, the reporting entries are derived from the accounting entries described with respect to steps 108 and 110. These entries are adapted specifically to be readable by a suitable payroll system or module.

At step 114, a payroll system is prevented from making a subsequent tax withholding payment substantially duplicative of the calculated tax withholding payment. Excess withholding payments can occur, for example, at the end of the payroll period when daily or other calculated tax withholding payments (typically resulting from non-standard compensation transactions) are not properly reconciled at the end of a payroll period. In certain of these embodiments, independent notification can occur as a result of optional step 112 in which non-standard compensation transactions are reported through the payroll system. For example, the tax payment module could receive a separate report of non-standard compensation transactions independent from the tax payment directive(s) described with respect to step 106. The report can be received at or just prior to, closing of a payroll period in which the transaction was initiated. The separate report can be sent to the payroll system directly from the brokerage firm module, and is then transmitted to the business unit accounting system. Alternatively, the payroll system can receive one or more separate reports from the brokerage module by way of the business unit accounting system.

Many payroll vendors configure their payroll and tax payment modules in such a way that any compensation and tax withholding payments flowing through the payroll module will trigger a corresponding tax withholding payment from the tax payment module. This helps the payroll vendor efficiently satisfy reporting and withholding requirements for most of their business clients. However, when withholding liabilities are paid to the tax authority on a more frequent basis in order to comply with additional regulatory requirements applicable to certain business units, reporting non-compensation transactions through the payroll system often results in the tax payment module making excess or even duplicate tax withholding payments as part of the standard payroll cycle or event. This can occur most frequently when the payment directives are sent directly to a tax payment module independently of a payroll module.

Step 114 is intended to prevent, or at least minimize, excess tax withholding payments. In certain embodiments of step 114, one or more reversal directives are automatically generated. The reversal directive(s) correspond to the payment directive(s) generated during step 106, and can be used to offset any daily or other calculated tax withholding payments against a subsequent tax withholding payment. The subsequent payment can be made along with any withholding payments resulting from the close of an ordinary payroll period. The reversal directive(s) can be aggregated and applied as a single entry to the tax payment module at, or just prior to, the close of ordinary payroll. Alternatively, reversal directive(s) can be individually generated and applied to the tax payment module at or just prior to the close of payroll. In certain embodiments, the timing and amount of each reversal directive is scheduled to match up with the payroll calendar such that the aggregated reversals generally offset the aggregated tax withholding payments made earlier during the applicable payroll period.

In one example, one or more payment directives are sent to the tax payment module prior to the closing of an ordinary payroll period. A computer system or module, which can be the same module that generated the earlier payment directive(s), automatically generates one or more tax reversal entries corresponding to the earlier payment directive(s). These tax reversal entries can be communicated to the tax payment module, and generally reflect credit(s) against tax withholding payment(s) previously made to the tax authority during the applicable payroll period. Reversal entries are sent and/or processed by the tax payment module around the close of a payroll period so that daily items can be reconciled with, and offset actual amounts reported through the payroll module as part of the ordinary payroll event. In this way, the vast majority of daily withholding liabilities can be paid in a timely manner, with final withholding payments and liabilities being reconciled normally as part of each ordinary payroll event.

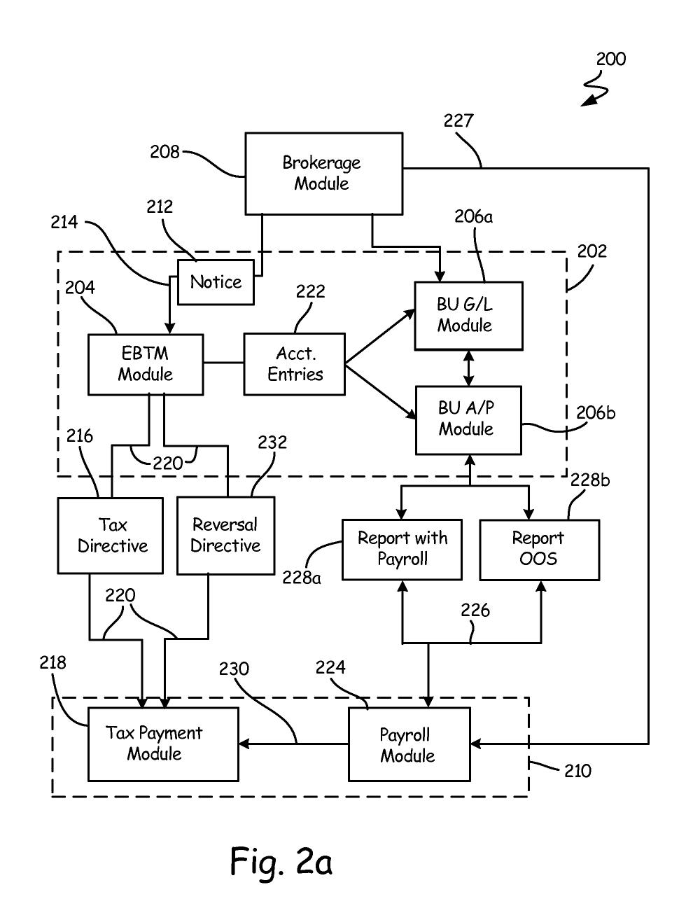

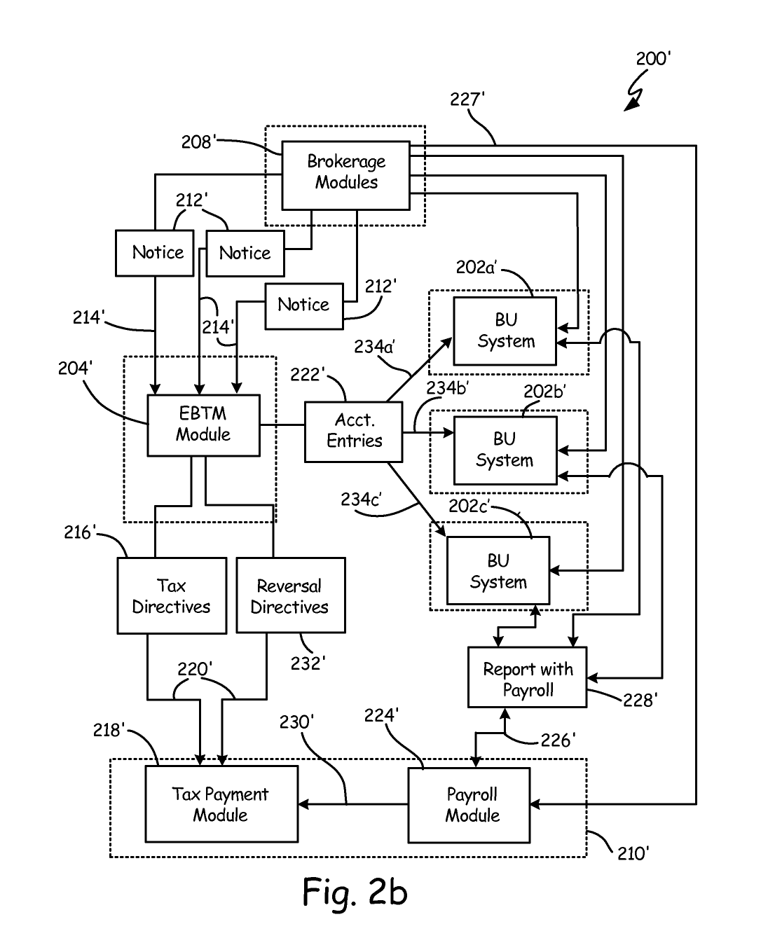

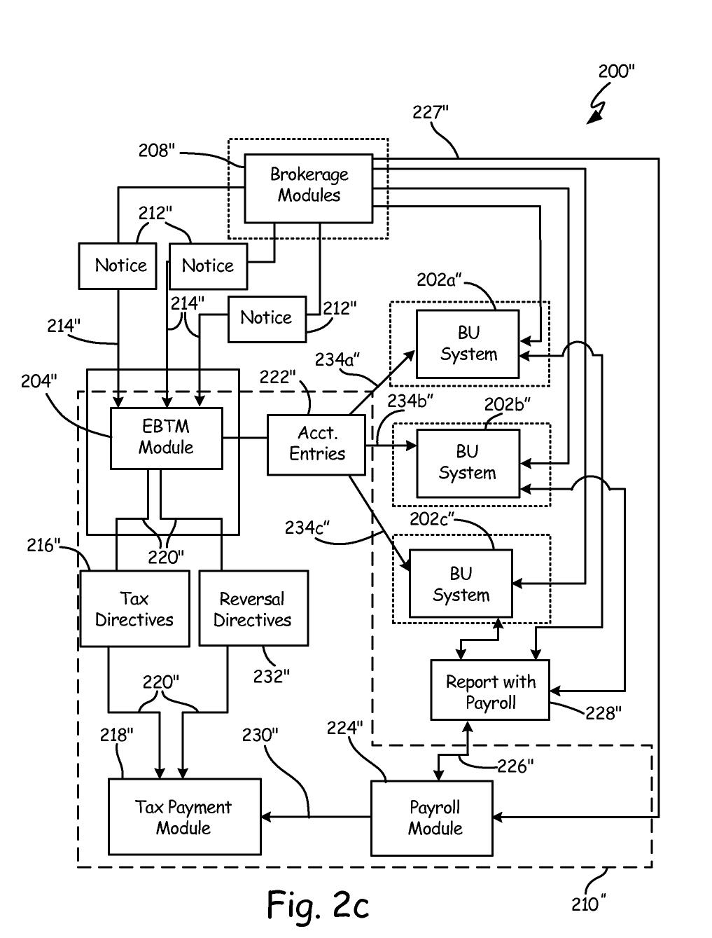

Generally, one or more of steps 102, 104, 106, 108, 110, and 114 can be programmed into a computerized equity based tax management (EBTM) module, which can automatically perform at least some of these steps. The EBTM module can be programmed with validation or approval modes which may require some human intervention to proceed with certain steps. However, the module can otherwise be adapted to run automatically. The EBTM module can operate independently, or as part of a larger accounting system. Several non-limiting examples of configurations incorporating an EBTM module are shown in FIGS. 2A-2C.

FIG. 2A shows a first example computer system 200 for managing tax withholding liabilities for non-standard compensation. In this example, BU accounting system 202 includes equity-based tax management (EBTM) module 204, general ledger module 206A, and accounts payable module 206B. In the example of FIG. 2A, BU accounting system 202 communicates with brokerage firm module 208 and vendor payroll system 210. FIGS. 2B and 2C, described later, show other system configurations which utilize an EBTM module.

EBTM module 204 can be programmed with relevant regulatory and compensation information so as to accurately track withholding liabilities and their due dates. Module 204 can take the form of a relational database or other system that is reconfigurable in view of changing regulations and types of compensation. This database can be compatible with the larger BU accounting system 202. Upon changes to compensation practices and/or regulations, scheduling or other variables used by module 204 can be updated accordingly.

In FIG. 2A, EBTM module 204 receives first electronic data file 212. First data file 212 contains details of any non-standard compensation transactions initiated during a time period covered by the notification. As described with reference to FIG. 1, a periodic notification can be received with information on whether or not a non-standard compensation transaction has been initiated during a time period covered by the notification. Here, that information is compiled in first electronic data file 212, which can describe the transactions in an aggregated and/or detailed data format.

In one example, first electronic data file 212 can contain information relevant to estimation of any tax withholding liabilities and their due dates. Non-limiting examples of relevant data can include identification of the beneficiary such as name, ID number, business unit (e.g., FEIN), active employment status, and pay group (salaried employee, executive, board member, other insider, etc.). Data also can include the type of transaction (e.g., SAR, NQSO, RSU, PSU, stock swap, etc.), quantity and/or market values of securities or instruments involved in each transaction, along with other specific details that can be used by EBTM module 204 in calculating withholding liabilities and due dates, as well as each employee's share of employment taxes. These details can also depend on the type of instrument, such as: basis, strike price, exercise price, deposit date, exercise date, settlement date, gross proceeds, among others.

First electronic data file 212 can be, for example, generated by a module designed for this purpose (e.g., brokerage firm module 208). In certain embodiments, brokerage firm system 208 is operated by a separate party tasked with managing securities and other instruments comprising non-standard compensation. First electronic data file 212 can include notification data in a file format (e.g., flat file format) compatible with EBTM module 204, and can be transmitted manually or automatically over secure connection 214 (e.g., HTTPS or Secure FTP). Alternatively, EBTM module 204 can initiate the file transfer and retrieve first electronic data file 212 over connection 214.

As noted above, current IRS regulations indicate that tax withholding liabilities are due on a funding day immediately following any day during which cumulative withholding liabilities for a single FEIN reaches a threshold of $100,000 (calculated using both standard and non-standard compensation). Thus, the time period covered by first electronic file 212 can be as short as single business day. However, in certain embodiments, EBTM module 204 is reconfigurable. For example, module 204 can be easily updated by a system administrator to adjust relevant time periods and threshold liability amounts adapted to regulatory changes.

In one illustrative example, EBTM module 204 receives first electronic data file 212 after market close on a normal Monday that is not a bank or other holiday. First electronic data file 212 can include data reflecting notification of any non-standard compensation transactions initiated during Monday's market period. It will be recognized that transaction requests may be submitted prior to Monday's market open (e.g., over the immediately preceding weekend). Those requests can be processed and exercised during Monday's market period and reflected in first file 212 as well.

Occasionally no equity-based compensation transaction will have been initiated during the time period covered by the notification. When this condition is detected, notification can include manually or automatically reviewing first electronic data file 204 to confirm this fact. The process then begins again for the next relevant time period.

Generally, integrity and accuracy of data contained in first electronic data file 212 can be manually and/or automatically validated (see, e.g., step 103 in FIG. 1). Validation can be done through communication of EBTM module 204 with other elements of BU accounting system 202. In one example, EBTM module 204 automatically generates a time-sensitive alert if first electronic data file 212 or other notification has not been received within an expected time interval after the end of the time period covered by the notification. EBTM module 204 can perform several other validation checks. One non-limiting example includes cross-checking notification data against whether each beneficiary is a member of a pay group subject to the withholding regulations. Certain pay groups may be subject to some but not all withholding requirements. Inactive employees or hourly employees can be excluded as part of the validation process. In another validation example, the exercise date(s) contained in the notification can be checked against the current processing date so as to ensure the due date is properly calculated.

After receipt and optional validation of first electronic data file 212, EBTM module 204 can automatically calculate any tax withholding liabilities payable to a tax authority. EBTM module 204 can be programmed with formulas representative of tax withholding regulations, including those applicable to non-standard compensation transactions. These regulations can include calculations for federal income tax, social security tax, Medicare tax, or other federal, state, and local withholding liabilities. As described with respect to step 104 shown in FIG. 1, these tax withholding liabilities can result from any non-standard compensation transactions reflected in first electronic data file 212.

The formulas used by EBTM module 204 can be based on one or more inputs received or derived from information reflected in first electronic data file 212. In certain embodiments, some or all of the taxable wages resulting from the non-standard compensation transaction can be an input used by EBTM module 204 to calculate federal, state, and/or local income tax withholding liabilities. Withholding can be based on a fixed or stepped percentage of the resulting taxable wages, and the daily or aggregate amounts may or may not be capped for a particular beneficiary and/or tax authority.

Taxes may also be split into employer and employee shares, as regulations dictate. For example, though an employer is held responsible for proper and timely remitting of all withholding liabilities, most federal and state income taxes are actually payable by, and credited to, each employee. Other taxes such as social security and Medicare taxes may have both employer and employee shares. In these examples, withholding liabilities for both employer and employee shares can be calculated separately by EBTM module 204 as a function of taxable wages reflected in the brokerage notification. Additionally or alternatively, withholding for an employer's share can be derived from a calculation of an employee's share, or vice versa.

Equity-based tax management module 204 can also be programmed with formulas representing regulations which determine the date on which tax withholding liabilities are due without penalty. In certain embodiments, the module can calculate the due date D of a particular withholding liability based on the initiation or exercise date E, settlement interval S, and a regulatory interval R. Generally speaking, the due date can be calculated automatically for each transaction by Equation 1:

D=E+S+R [1]

Settlement date interval S can depend on the type of transaction. For example, Stock Appreciation Rights (SAR's), Restricted Stock (RS), Restricted Stock Units (RSU's), and Performance Stock Units (PSU's), have a settlement date interval S of one business day, while current IRS guidance allows Non-Qualified Stock Options (NQSO's) to have a settlement date interval S of up to three business days without penalty. Regulatory interval R is based on requirements of the tax authority. The IRS currently has a $100,000 next day funding rule. When this rule is triggered, R is equal to 1, meaning that employers who have accumulated $100,000 or more of unpaid tax withholding liabilities against one particular FEIN are required to deposit their entire outstanding tax withholding liability by the next funding day. Funding days include most business days with the exception of certain other bank holidays. The amount is cumulative of all unpaid withholding liabilities, and the next funding day deposit is due regardless of whether the employer is otherwise a monthly or semiweekly schedule depositor.

In one example, a batch of NQSO's are initiated by a qualified beneficiary with an effective exercise date E of Monday. The value of tax withholding liabilities on this non-standard compensation transaction is assumed to be $50,000. Since NQSO's have a settlement interval S of up to three business days, the effective settlement date of the transaction is Thursday if there are no intervening holidays. If the BU's other outstanding withholding liabilities trigger the $100,000 next day rule on Thursday, R will have a value of 1 and the due date will be calculated to be the next funding day, typically Friday of the same week. In the event Friday is not a funding day, D is the next funding day, such as the following Monday.

Alternatively, the BU's other outstanding withholding liabilities do not trigger the $100,000 next day rule on Thursday. The cumulative withholding liabilities can be rolled over to the next business day (Friday). The value R can then be calculated to reflect this. When the $100,000 next day rule is eventually triggered, R will then be set to 1, and all accumulated unpaid liabilities for the FEIN become due and payable on the following funding day. It should be noted that cumulative liabilities can include any and all withholding liabilities attributable to a particular FEIN, including those from both standard and non-standard compensation.

After calculating the withholding liabilities, EBTM module 204 automatically generates second electronic data file 216, which contains one or more directives for a tax withholding payment to be made to the tax authority. The directive(s) can include data which describes how and when payment(s) are to be applied against the calculated tax withholding liabilities. Generally, these payments are scheduled to be made on or before a date that the calculated withholding liabilities are due to the tax authority (e.g., due date D).

The format of second electronic data file 216 should be compatible with tax payment module 218, such as a flat file format. Similar to first electronic data file 212 transmission of second electronic data file 216 can take place over a secure connection 220. Transmission can be initiated through EBTM module 204 and/or tax payment module 218.

In the example shown in FIG. 2A, payroll system 210 is configured primarily to handle tax withholding for standard cash-based compensation. In certain embodiments, a payroll or other vendor uses payroll system 210 to provide payroll services to the business unit responsible for funding the tax withholding payment. Payroll system 210, which also includes tax payment module 218, can be programmed to treat tax payment directives as a directive to fill out and file any required tax withholding forms or schedules (e.g., IRS Form 941) on behalf of the business unit. Alternatively, second electronic file 218 can be formatted with separate data for filing any required tax forms.

In addition to other tasks, EBTM module 204 can also be configured to automatically generate third electronic data file 222, which contains one or more accounting entries for BU accounting system 202. The accounting entries record payments to the tax authority made and applied according to directives contained in second electronic data file 216. The accounting entries can thus be generated in conjunction with generating the directives contained in second electronic data file 216.

EBTM module 204 can generate the accounting entries in third electronic data file 218 to serve various purposes. For example, an entry can be required merely for recording payment(s) in general ledger (G/L) module 206A. However, in certain embodiments, separate accounting entries are required to ensure tax withholding payments are properly funded via accounts payable (A/P) module 206B. This can entail, for example, EBTM module 204 generating and transmitting third electronic data file 218 or its equivalent to accounts payable (A/P) module 206B. Alternatively, G/L module 206A records the accounting entries in third electronic data file 218 and converts the entries into one or more funding requests sent to A/P module 206B. The funding requests ensure sufficient funds are available to tax payment module 218. Another potential use for these accounting entries includes recording the non-standard compensation and withholding payments for later transmittal to payroll system 210. Accounting entries also can be used to perform additional tasks related to minimizing excess or duplicate withholding payments.

Upon settlement, net proceeds of any non-standard compensation transaction(s) can be made available to the beneficiary. The amount and type of proceeds vary, but usually consist of cash and/or securities deposited into a brokerage firm account on behalf of the beneficiary. To enable accurate tracking of all (standard and non-standard) compensation from various sources, the net proceeds and corresponding tax withholding payments can be reported to the payroll vendor via secure communication between EBTM module 204 and payroll module 224 over secure connection 226. Payroll module 224 can also receives a separate report of the non-standard compensation transactions. In certain embodiments, the report is received at, or just prior to, the close of an ordinary payroll period or out-of-sequence payroll period.

In certain embodiments, the non-standard compensation transactions are reported as part of an ordinary payroll event. This can be done through automatic generation of fourth electronic data file 228A after receipt of first (notification) file 212, and estimation of any tax withholding liabilities by module 204. Fourth electronic data file 228A can be generated by BU accounting system 202 and transmitted to payroll module 224 at, or just prior to closing of the ordinary payroll period. Fourth electronic data file 228A can contain one or more data entries reflecting net proceeds of any non-standard compensation transactions and any corresponding tax withholding payments made prior to the close of the payroll period. In one example, the data entries in fourth electronic data file 228A can be generated from accounting entries in second electronic file 218, which were previously generated by EBTM module 204. Alternatively, fourth electronic data file 228A can be generated directly by EBTM module 204 or brokerage module 208 and transmitted to payroll module 224 at or just prior to close of the ordinary payroll period. In the case where brokerage module 208 generates some or all of this data, fourth electronic data file 228A can alternatively be transmitted directly to payroll module 224 over secure connection 227.

In certain alternative embodiments, non-standard compensation transactions are reported outside of ordinary payroll events. This is sometimes referred to as an out-of-sequence (OOS) payroll event. In one example, EBTM module 204 automatically generates fifth electronic data file 228B after receipt of first (notification) file 212, and estimation of any tax withholding liabilities. Fifth electronic data file 228B can alternatively be generated by modules 206A, 206B, and/or 208 and transmitted to payroll module 224 at or just prior to closing OOS payroll. Brokerage module 208 can transmit data directly to payroll module 224 over secure connection 227.

Fifth electronic data file 228B can contain data entries related to the OOS payroll event and reflect net proceeds of any non-standard compensation transaction as well as any corresponding tax withholding payments. In this case, the data entries in fifth electronic data file 228B can be generated in conjunction with generation of second electronic file 218. In certain embodiments, tax payment module 218 is configured to receive all compensation data handled by payroll module 224 (via connection 230). While this allows tax withholding payments to be automatically calculated and remitted to the tax authority, reporting non-standard compensation transactions to payroll module 224 effectively directs tax payment module 218 to make one or more subsequent tax withholding payments. Absent further action, the subsequent tax withholding payment(s) are substantially duplicative of the calculated tax withholding payment (s) made in response to processing of second electronic data file 216.

In one simplified example, $100,000 of non-standard compensation results in $25,000 in withholding liabilities for the business unit. $75,000 of net proceeds is then deposited in the beneficiary's brokerage account five business days before close of an ordinary payroll period. On the directive of EBTM module 204, tax payment module 218 remits $25,000 to the tax authority on the funding day immediately following the $75,000 brokerage deposit. This directive does not pass through payroll module 224. Upon closing of ordinary payroll, the $100,000 in non-standard compensation and the $25,000 tax withholding payment are reported to payroll module 224 for the first time. If payroll module 224 is configured to treat reporting of these payments as an instruction to tax payment module 218, tax payment module 218 would then remit a duplicate or excess $25,000 tax payment absent further action.

In response to this configuration, EBTM module 204 can prevent payroll system 210 from making a subsequent tax withholding payment substantially duplicative of the earlier calculated tax withholding payment. This can be done by way of a subsequent communication between equity-based tax management module 204 and payroll system 210 (e.g., tax payment module 218). The communication is intended to offset or reverse calculated payments made prior to the end of the payroll period.

In certain embodiments, EBTM module 204 generates sixth electronic data file 232, which includes data reflecting one or more tax reversal entries, which effectively offset tax withholding payment(s) made earlier during a payroll period. EBTM module 204 can transmit sixth electronic data file 232 directly or indirectly to tax payment module 218. File 232 can include an offsetting entry for each daily tax withholding payment, an aggregation of daily tax withholding payments, or a single reversal of all tax payments made during the payroll period.

Sixth electronic data file 232 has been described as being generated and transmitted by EBTM module 204. In alternative embodiments, sixth electronic data file 232 can instead be generated or transmitted by other modules in response to instructions received from EBTM module 204. Examples include but are not limited to payroll module 224, tax payment module 218, and BU accounting modules 206A, 206B.

EBTM module 204 can be configured to coordinate daily tax withholding payments with less frequent tasks such as generation and transmission of tax reversal entries (e.g., sixth electronic data file 232). Generation and transmission of tax reversal entries can be scheduled manually or automatically to coincide with the payroll calendar. In one example, ordinary payroll periods are scheduled prior to the start of a calendar or fiscal year, with the end of each ordinary payroll period often preceding the actual payroll event by several business days (e.g., a payroll event scheduled for the 15^{th} day of a month may close on the 10^{th}).

As noted above, EBTM module 204 is integrated with BU accounting system 202. Thus, EBTM 204 is under the control of a business unit responsible for funding the non-standard compensation transaction(s). As such, the business unit is the primary entity which coordinates management of its tax withholding liabilities. It will be recognized that a single EBTM module 204 can manage tax withholding liability payments for a number of affiliated business units. For example, a corporation can utilize a central accounting system with a single EBTM module which coordinates with the accounting systems of each of its subsidiaries and/or operating companies. Alternatively, each affiliated business unit operates its own accounting system which includes an EBTM module 204. FIGS. 2B and 2C show other examples where an EBTM module is located outside a BU accounting system and where tax withholding liability payments are coordinated by vendors or consultants providing services to one or more business unit(s).

FIG. 2B shows system 200′, an alternative embodiment of system 200 shown in FIG. 2A. This is a configuration suitable for a third party business consulting vendor hosting EBTM module 204′ as part of a larger computer system. The business consulting vendor can provide consulting services to one or more business units responsible for funding tax withholding payments, not all of which are necessarily affiliated or commonly owned.

In FIG. 2B, system 200′ includes EBTM module 204′ operating independently of BU accounting systems 202′, and payroll vendor system 210′. Here, EBTM module 204′ is configured to securely interface with individual BU accounting systems 202A′, 202B′, 202C′. Secure data connections 234A′, 234B′, 234C′ can be established between EBTM module 204′ and the respective individual BU accounting systems 202A′, 202B′, 202C′. EBTM module 204′ receives first electronic data file 212′, and calculates tax withholding liabilities as described with respect to FIG. 1. EBTM module 204′ also generates second electronic data file 216′ containing one or more directives for tax payment module 218′ to make a withholding payment to a tax authority. This is also similar to second electronic data file 216 shown in FIG. 2A. EBTM module 204′ can also be configured to automatically generate accounting entries reflecting any tax withholding payments covered by the directive(s). EBTM module 204′ can be configured to work in conjunction with each BU accounting system 202′ in order to report non-standard compensation transactions and corresponding tax withholding payments through the payroll system. Certain embodiments of EBTM module 204′ also prevent excess tax withholding payments from being made to the tax authority.

With some exceptions, system 200′ shown in FIG. 2B operates generally in the same manner as system 200 shown in FIG. 2A. There are several adaptations to EBTM module 204′ so that it can respond properly in different environments. Non-limiting examples of possible adaptations are described below.

In FIG. 2B, EBTM module 204′ is configured to generate a third electronic data file 222′ for each corresponding BU accounting system 202′. Third electronic data files 222′ can be generated in or converted to any common or specialized data format readable by the corresponding BU accounting system 202′. For example, BU accounting system 202A′ can be created on the SAP platform, while BU accounting system 202B′ is based on Oracle software. EBTM module 204′ can thus be configured to generate one version of third electronic data file 222′ readable by SAP software, and another version readable by Oracle software. Alternatively, a common data file is generated and converted by each accounting system 202A′.

Non-standard compensation transactions can be reported through payroll system 210′ as was described with respect to FIG. 2A. The non-standard compensation transactions and tax withholding payments can be reported as part of an ordinary payroll event through automatic generation of fourth electronic data file 228A′, which is then transmitted to payroll module 224 at or just prior to closing of the ordinary payroll period. Reported non-standard compensation transactions and tax withholding payments can be based on compensation and withholding values received and calculated by module 204′. Alternatively, each corresponding BU accounting system 202 independently calculates the final (settlement) value of non-standard compensation transactions and corresponding final tax withholding liabilities. These final values can differ slightly from compensation and withholding values received and calculated by module 204′.

In alternative embodiments, non-standard compensation transactions and tax withholding payments can be reported outside of an ordinary payroll event through automatic generation of fifth electronic data file 228B′. The reported non-standard compensation transactions and tax withholding payments can be based on compensation and withholding values received and calculated by EBTM module 204′. Alternatively, each corresponding BU accounting system 202 independently calculates the final (settlement) value of non-standard compensation transactions and corresponding final tax withholding liabilities occurring during a period covered by an out-of-sequence payroll event. These final values can also differ slightly from compensation and withholding values received and calculated by module 204′.

EBTM module 204′ can also be configured to prevent excess or duplicate tax withholding payments in response to reporting non-standard compensation transactions and tax withholding payments through payroll system 210′ Similar to FIG. 2A, certain embodiments of vendor tax payment module 218′ are configured to interface directly with payroll module 224′ over connection 230′, which allows tax payment module 218′ to automatically remit tax withholding payments for compensation reported through payroll module 224′. In response to this configuration, EBTM module 204′ can be configured to manually or automatically prevent excess tax withholding payments for non-standard compensation transactions and tax withholding payments.

In one example, excess tax withholding payments are prevented via subsequent communication between equity-based tax management module 204′ and tax payment module 218′. The communication is intended to offset or reverse payments made during the payroll period. In certain embodiments, EBTM module 204′ is configured to generate sixth electronic data file 232′, which includes data reflecting one or more tax reversal entries effectively offsetting the tax withholding payment(s) made earlier during a payroll period. Sixth electronic data file 232 can be transmitted directly or indirectly to tax payment module 218 from EBTM module 204. Generation and transmission of tax reversal entries can be manually or automatically scheduled to coincide with the payroll calendar of each business unit.

FIG. 2C shows system 200″ with EBTM module 204″ integrated with the vendor payroll system 210″. System 200″ operates in a manner similar to that described in FIG. 2B, where EBTM module 204″ communicates securely with a plurality of BU accounting systems 202A″, 202B″, 202C″. In this configuration, EBTM module 204″ can be operated as a module separate from vendor payroll module 224″ and tax payment module 218″. Alternatively, the different functions of EBTM module 204″ can be split among vendor payroll module 224″, tax payment module 218″, and/or other modules (not shown) operated as part of payroll system 210″.

While equity-based tax management module 202 can generate directives for tax payments to be made in an amount equal to or greater than a sum of the calculated tax withholding liabilities, some external factors can be present on any given funding day that indicate the actual amount due varies from the calculated amount. The amount can then be manually or automatically adjusted through the tax payment module to reflect actual amounts due on a particular funding day. Similarly, the calculated liabilities paid before the close of the ordinary payroll period can be reconciled at or near the end of the ordinary payroll period through use of actual data reflecting settled non-standard compensation data. This data is received from the brokerage firm or other vendor.

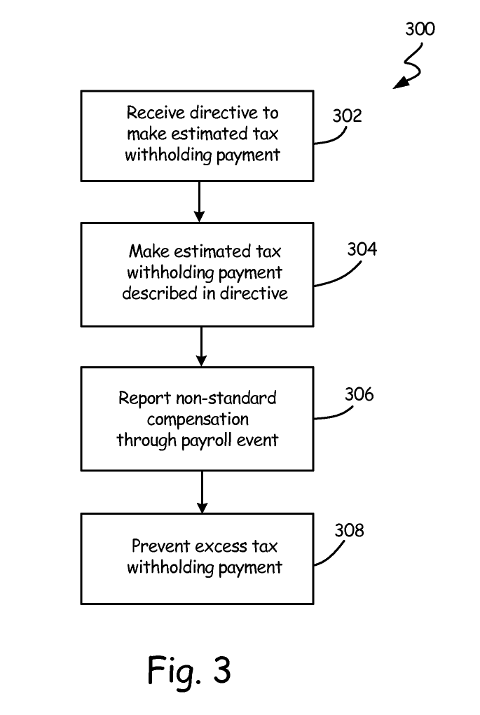

FIG. 3 shows method 300 for managing tax withholding liabilities using a payroll system. At least some of the tax withholding liabilities can result from non-standard compensation transactions. The payroll system can include at least a payroll module and a tax payment module. The payroll module and/or the tax payment module can receive instructions from an EBTM module or equivalent. In certain embodiments, the EBTM module is part of an accounting system managed by at least one business unit responsible for funding a calculated tax withholding payment. In certain alternative embodiments, the EBTM module is integrated with the payroll system operated by a vendor providing payroll services to at least one business unit responsible for funding a calculated tax withholding payment. In certain other alternative embodiments, the EBTM module is part of a computer system managed by a business consulting firm providing consulting services to at least one business unit responsible for funding a calculated tax withholding payment.

Method 300 comprises step 302 which describes receiving a directive for making a calculated tax withholding payment. The calculated tax withholding payment can be made by, or on behalf of a business unit providing non-standard compensation to an employee or other beneficiary. In one example, the tax withholding payment is actually made by an operator of a computerized payroll system such as a payroll vendor. The tax withholding payment can be made prior to an ordinary payroll event

Generally, directive(s) for making a tax withholding payment can be generated according to step 106 of method 100 (shown in FIG. 1). The directive(s) can be received in electronic form, such as in the form of a second electronic data file described with respect to FIGS. 2A-2C. FIG. 2A shows one example configuration where EBTM module 204 generates tax payment directives, which are subsequently received by payroll module 224. Since FIG. 2A shows EBTM module 204 as part of BU accounting system 202, the directive can be generated under the control of the business unit funding the non-standard compensation. FIGS. 2B and 2C show other examples where the EBTM module is operated independently of BU accounting system 202. In those examples, the directive can be generated under the control of a vendor, consultant, or other third party. However, in most cases, the business unit provides actual funding of the tax withholding payment via the tax payment module.

Step 304 can be performed in response to the directive of step 302, and includes making the tax withholding payment as described in the directive. The tax withholding payment is made on or before a due date of the tax withholding liability resulting from settlement of a non-standard compensation transaction. Since certain embodiments of the tax payment module are configured to primarily receive payment directives from a payroll module, the directive(s) for making a tax withholding payment can be generated in a form that is directly readable by the tax payment module. In one example, due date information is also received as part of second electronic file 216.

According to step 306, any non-standard compensation transactions and corresponding tax withholding liabilities can be reported through a payroll system. This can be done as part of an ordinary payroll event or outside of the ordinary payroll event such as an out-of-sequence (OOS) event. Again referring back to FIGS. 2A-2C, reporting non-standard compensation, and corresponding withholding payments can be performed by transmitting the appropriate payroll and/or accounting entries to payroll module 224. Payroll module 224 receives the entries and generates the appropriate reporting documentation for the business unit, beneficiary, and/or tax authority.

Step 308 includes preventing the payroll system from making a subsequent tax withholding payment substantially duplicative of the calculated tax withholding payment. The payroll system can receive a separate report of non-standard compensation transactions occurring during a payroll period. This report can be used to reconcile any differences between the calculated withholding payments and actual liabilities determined after settlement of the non-standard compensation transactions. However, it was previously described how reporting transactions and tax payments through existing channels (e.g. payroll system 210 shown in FIG. 2A) can result in an excess or duplicate of the calculated tax payment absent any additional actions. This is because most payroll systems are configured to quickly and efficiently receive data in the payroll module, calculate withholding, and direct the tax payment module to automatically remit funds to the tax authority as part of ordinary payroll events.

As such, step 308 is intended to prevent a substantially duplicative tax payment from being made in response to reporting and/or reconciling non-standard compensation transactions through the payroll system. As shown and described with respect to FIGS. 2A-2C, this can be done by way of a subsequent communication between an EBTM module and a tax payment module. The communication is intended to offset or reverse tax withholding payments made during the payroll period. In certain embodiments, the communication includes one or more tax reversal entries.

Using the example of FIG. 2A, tax payment module 218 receives sixth electronic data file 232, which includes data reflecting one or more tax reversal entries. These entries effectively offset tax withholding payment(s) made earlier during a payroll period. Sixth electronic data file 232 can be transmitted directly or indirectly to tax payment module 218 from EBTM module 204, and can be manually or automatically scheduled to coincide with the payroll calendar of the relevant business unit. Thus in certain embodiments, an excess or duplicate tax withholding payment can be effectively prevented, for example, by receiving and processing one or more tax reversal entries. These entries effectively reverse any duplicate payments initiated by reporting the non-standard compensation transaction as part of the next ordinary payroll event. Reversal entries or other communications can be generated by EBTM module 204 as described with reference to FIGS. 2A-2C. Alternatively, these entries can be generated by the payroll vendor or the BU accounting system(s) by aggregating records of calculated tax payments made prior to the close of the ordinary payroll period.

While described with respect to federal tax law and regulations, it will be appreciated that the subject matter can be readily adapted to laws of other governmental subdivisions applicable to employment taxes or other withholding requirements and liabilities.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A computer-implemented method for managing tax withholding liabilities, the method comprising:
receiving a notification of a non-standard compensation transaction initiated during a time period covered by the notification;
automatically calculating a tax withholding liability resulting from the non-standard compensation transaction;
automatically generating a directive for a calculated tax withholding payment to be made and applied against the calculated tax withholding liability, the calculated payment to be made to a tax authority on or before a calculated due date of the tax withholding liability.

2. The computer-implemented method of claim 1, wherein the notification time period is less than an ordinary payroll time period.

3. The computer-implemented method of claim 2, wherein the calculated due date of the tax withholding liability precedes a due date of tax withholding liabilities resulting from an ordinary payroll event.

4. The computer-implemented method of claim 1, wherein the notification time period reflects no more than a single business day or market day immediately preceding receipt of the notification.

5. The computer-implemented method of claim 1, wherein the non-standard compensation transaction is an equity-based transaction.

6. The computer-implemented method of claim 5, wherein the equity-based transaction involves at least one of: stock appreciation rights (SAR), non-qualified stock options (NQSO), restricted stock (RS), restricted stock units (RSU), and performance stock units (PSU).

7. The computer-implemented method of claim 1, wherein an amount of the calculated tax withholding payment is equal to or greater than the calculated tax withholding liability.

8. The computer-implemented method of claim 1, further comprising:
automatically generating an accounting entry for recording the calculated tax withholding payment.

9. The computer-implemented method of claim 1, further comprising:
preventing a payroll system from making a subsequent tax withholding payment substantially duplicative of the calculated tax withholding payment.

10. The computer-implemented method of claim 9, wherein the payroll system is managed by a payroll vendor.

11. The computer-implemented method of claim 9, wherein the payroll system receives a separate report of the non-standard compensation transaction at, or just prior to, the end of a payroll period in which the transaction was initiated.

12. The computer-implemented method of claim 9, wherein the preventing step includes automatically generating a tax reversal directive for offsetting the calculated tax withholding payment against a subsequent tax withholding payment.

13. The computer-implemented method of claim 12, wherein the tax reversal directive is transmitted to the payroll system at, or just prior to, the close of an ordinary payroll period.

14. The computer-implemented method of claim 1, further comprising:
automatically generating an alert that no non-standard compensation transaction has occurred during the notification time period.

15. The computer-implemented method of claim 1, further comprising:
prior to the calculating step, automatically validating integrity of the notification.

16. The computer-implemented method of claim 15, wherein the validation step includes automatically generating an alert if the receiving step has not occurred within an expected time interval after the end of the time period covered by the notification.

17. A computer-implemented method for managing tax withholding liabilities, the method comprising:
receiving a first electronic data file containing notification of one or more non-standard compensation transactions initiated during a notification time period;
automatically calculating one or more tax withholding liabilities which result from any non-standard compensation transaction notifications contained in the first electronic data file; and
automatically generating a second electronic data file containing a directive for a tax payment module to make and apply a tax withholding payment against the one or more calculated tax withholding liabilities, the tax withholding payment to be made to a tax authority on or before a due date.

18. The computer-implemented method of claim 17, wherein one or more steps of the method are performed by an equity-based tax management (EBTM) module.

19. The computer-implemented method of claim 18, wherein the EBTM module is part of an accounting system providing accounting services to at least one business unit responsible for funding the tax withholding payment.

20. The computer-implemented method of claim 18, wherein the EBTM module is part of a payroll system managed by a payroll vendor providing payroll services to at least one business unit responsible for funding the tax withholding payment.

21. The computer-implemented method of claim 18, wherein the EBTM module is part of a computer system managed by a business consulting vendor providing consulting services to at least one business unit responsible for funding the tax withholding payment.

22. The computer-implemented method of claim 17, further comprising:
automatically generating a third electronic data file containing at least one accounting entry for recording any calculated tax withholding payments made to the tax authority.

23. The computer-implemented method of claim 17, wherein the first electronic data file is received from a brokerage module.

24. The computer-implemented method of claim 17, wherein the payment to the tax authority is made in an amount equal to or greater than a total of any calculated tax withholding liabilities.

25. The computer-implemented method of claim 17, wherein the tax payment module is part of a payroll system managed by a payroll vendor providing payroll services to at least one business unit responsible for funding the tax withholding payment.

26. The computer-implemented method of claim 25, wherein the payroll system also includes a payroll module which receives a separate report of the one or more non-standard compensation transactions.

27. The computer-implemented method of claim 26, wherein the separate report is contained in a fourth electronic data file received by the payroll system at or just prior to the close of an ordinary payroll period.

28. The computer-implemented method of claim 26, wherein the separate report is contained in a fifth electronic data file received by the payroll system at or just prior to the close of an out-of-sequence (OOS) payroll period.

29. The computer-implemented method of claim 17, further comprising:
preventing a payroll system from making a subsequent tax withholding payment substantially duplicative of the calculated tax withholding payment.

30. The computer-implemented method of claim 29, wherein the preventing step includes automatically generating at least one tax reversal directive for offsetting any calculated tax withholding payments against a subsequent tax withholding payment.

31. The computer-implemented method of claim 30, wherein the at least one tax reversal directive is transmitted to the tax payment module at or just prior to the close of an ordinary payroll period.

32. The computer-implemented method of claim 30, wherein the at least one tax reversal directive is contained in a sixth electronic data file.

33. The computer-implemented method of claim 17, wherein at least one of the non-standard compensation transactions is an equity-based transaction.

34. The computer-implemented method of claim 33, wherein the equity-based transaction involves at least one of: stock appreciation rights (SAR), non-qualified stock options (NQSO), restricted stock (RS), restricted stock units (RSU), and performance stock units (PSU).

35. The computer-implemented method of claim 17, further comprising:
reviewing the first electronic file to confirm that no equity-based compensation transaction has been initiated during the time period covered by the notification

36. The computer-implemented method of claim 17, further comprising:
validating the data contained in the first electronic data file.

37. The computer-implemented method of claim 36, wherein the validating step includes automatically generating a time-sensitive alert if the first electronic data file has not been received within an expected time interval after the end of the time period covered by the notification.

38. The computer-implemented method of claim 35, wherein the first electronic data file is scheduled to be received once per business day.

39. The computer-implemented method of claim 17, wherein a due date of any tax withholding liability is automatically calculated based on a settlement date for each non-standard compensation transaction initiated during the time period.

40. The computer-implemented method of claim 39, wherein the due date is based on a predetermined time interval after the settlement date.

41. The computer-implemented method of claim 40, wherein the predetermined time interval is based on a total amount of unpaid tax withholding liabilities accumulated up to and including each settlement date, the accumulated unpaid tax withholding liabilities including both standard compensation and non-standard compensation.

42. A computer-implemented method for managing tax withholding liabilities using a payroll system, the method comprising:
receiving a tax payment directive after initiation of a non-standard compensation transaction;
making a calculated tax withholding payment described in the directive on or before a due date of a calculated tax withholding liability, the calculated tax withholding liability resulting from the non-standard compensation transaction; and
preventing the payroll system from making a subsequent tax withholding payment substantially duplicative of the calculated tax withholding payment.

43. The computer-implemented method of claim 42, wherein the directive is received each business day.

44. The computer-implemented method of claim 42, wherein the payroll system records both standard compensation and non-standard compensation.

45. The computer-implemented method of claim 42, wherein the payroll system is managed by a payroll vendor providing payroll services to at least one business unit responsible for making the calculated tax withholding payment.

46. The computer-implemented method of claim 42, wherein the payroll system comprises a tax payment module configured to perform the making step.

47. The computer-implemented method of claim 46, wherein the payroll system further comprises a payroll module configured to automatically provide notification of all reported compensation to the tax payment module.

48. The computer-implemented method of claim 47, wherein the payroll module is configured to receive a report of the non-standard compensation transaction separate from the tax payment module receiving the payment directive.

49. The computer-implemented method of claim 48, wherein the separate report is received by the payroll module at, or just prior to, the close of an ordinary payroll period.

50. The computer-implemented method of claim 48, wherein the separate notification is received by the payroll module at, or just prior to, the close of an out-of-sequence (OOS) payroll period.

51. The computer-implemented method of claim 42, wherein the tax payment directive is automatically generated by an equity-based tax management (EBTM) module.

52. The computer-implemented method of claim 51, wherein the EBTM module is part of an accounting system managed by at least one business unit responsible for funding the tax withholding payment.

53. The computer-implemented method of claim 51, wherein the EBTM module is integrated with the payroll system.

54. The computer-implemented method of claim 51, wherein the EBTM module is part of a computer system managed by a business consulting firm providing consulting services to at least one business unit responsible for funding the tax withholding payment.

55. The method of claim 42, further comprising:
reporting the non-standard compensation transaction through the payroll system.

56. The computer-implemented method of claim 42, wherein the due date of the tax withholding liability precedes a due date of tax withholding liabilities resulting from an ordinary payroll event.

57. The method of claim 42, wherein the non-standard compensation transaction is an equity-based transaction.

58. The method of claim 57, wherein the equity-based transaction involves at least one of: stock appreciation rights (SAR), non-qualified stock options (NQSO), restricted stock (RS), restricted stock units (RSU), and performance stock units (PSU).
